(19) United States
(12) Patent Application Publication
(10) Pub. No.: US 2008/0223548 A1
(43) Pub. Date: Sep. 18, 2008

(54) Air Conditioning System for a Vehicle

(76) Inventor: Henri Treu, St. Pere en Retz (FR)

Correspondence Address: DICKINSON WRIGHT PLLC, 1901 L. STREET NW, SUITE 800, WASHINGTON, DC, 20036, US

(21) Appl. No.: 11/994,160

(22) PCT Filed: Sep. 16, 2005
(86) PCT No.: PCT/DE05/01623

§ 371 Date: Dec. 28, 2007

(30) Foreign Application Priority Data
Jul. 1, 2005 (DE) 10 2005 031 220.9

(51) Int. Cl. B60H 1/00; F25B 29/00

(52) U.S. Cl. 165/61; 165/122

(57) ABSTRACT

The invention relates to an air conditioning system for a vehicle, comprising a heat exchanger (10) which can be penetrated by air and is connected to a first air duct (12) and to at least one second air duct (14) extending into zones (18, 20) that are to be air-conditioned. A first fan (24) and the second fan (26) are designed for sucking in air discharged from the heat exchanger (10) so as to deliver air to the zones (18, 20) that are to be air-conditioned.

The invention relates to an air-conditioning system for a vehicle, having a heat exchanger which can be traversed by air and which is connected to a first air duct and to at least one second air duct which lead into regions to be air-conditioned of the vehicle.

An air-conditioning system of said type which is provided for a motor vehicle is known for example from DE 195 39 517 A1 which shows the typical construction of nowadays conventional air-conditioning systems. Here, at least one heat exchanger is arranged on the discharge air side of a fan which feeds the air which is to be supplied via a plurality of air ducts to different regions of the vehicle interior space. The outlet regions of at least some of the air ducts are conventionally provided with devices with which the outflow of air can be completely or partially prevented depending on the desire of the occupant to whom the respective air outlet is assigned. If an air outlet is completely or partially closed off by an occupant, this leads to the air fed by the central fan being accumulated in the respective air duct.

A disadvantage of the known generic air-conditioning systems is that the devices for partially or completely closing off the air outlets must be of solid construction in order to be capable of completely or partially preventing air from emerging despite the running fan. In addition, the accumulation of air fed by the central fan caused by closed air outlets leads to energy losses.

The object of the present invention is that of eliminating the above-mentioned disadvantages of the prior art.

Said object is achieved by means of the features of claim 1.

Advantageous refinements and embodiments of the invention can be gathered from the dependent claims.

The air-conditioning system according to the invention builds on the generic prior art in that the first air duct is assigned a first fan and the second air duct is assigned a second fan, with the first fan and the second fan being designed to suck air emerging from the heat exchanger in order to supply air to the regions to be air-conditioned of the vehicle. Here, a vehicle is to be understood to mean all types of land- or sea-going means of transport, in particular automobiles, camping vehicles or boats. By means of the solution according to the invention, the air is sucked by the respective fan through the heat exchanger. If a vehicle occupant desires no supply or air, then the fan which is assigned to the respective air duct can for example be simply shut off. An accumulation of air can thereby be prevented. It is also possible to dispense with devices with which the outflow of air can be completely or partially prevented.

In preferred embodiments of the air-conditioning system according to the invention, it is provided that the first fan is arranged in an outlet region of the first air duct and that the second fan is arranged in an outlet region of the second air duct. Said solution is particularly advantageous firstly because there is usually more installation space available for the fan in the outlet region and secondly because the fan can be optimized for purely suction operation.

At least in some embodiments of the air-conditioning system according to the invention, it can also be provided that the heat exchanger is assigned a further fan. Said further fan is however preferably provided less for pushing air through the system than for supplying the heat exchanger with sufficient fresh air or air sucked in from the interior space of the vehicle.

According to one advantageous refinement of the invention, it is provided that the air feed quantity of at least one of the fans can be regulated. In the simplest case, the regulation of the fan can take place for example by means of a potentiometer which is to be operated by the respective occupant.

It is however preferably provided that the air feed quantity of the first fan can be regulated as a function of the temperature in the region to be air-conditioned of the vehicle into which the first air duct leads and that the air feed quantity of the second fan can be regulated as a function of the temperature in the region to be air-conditioned of the vehicle into which the second air duct leads. For this purpose, one or more of the regions to be air-conditioned of the vehicle can be assigned a temperature sensor which is connected to a controller which activates the respective fan. It is therefore possible to form a plurality of closed regulating circuits, with it being possible for the respective occupant to predefine the respective nominal temperature for example by means of an operating button.

It is preferably provided in the air-conditioning system according to the invention that the heat exchanger is designed to supply heat and/or cold to the air which flows through it. Here, the heat exchanger can also be formed by a plurality of partial heat exchangers which are arranged in parallel or in series and of which for example one partial heat exchanger is provided to supply heat while another partial heat exchanger is provided to supply cold.

The invention can be particularly advantageously used in cases in which it is provided that the region to be air-conditioned into which the first air duct leads is structurally separate from the region to be air-conditioned into which the second air duct leads. For example, the first air duct can be assigned to the front region of a vehicle interior space while the second air duct can be assigned to the rear region of a vehicle. In utility vehicles, it is for example possible for one air duct to lead into the driver's cabin and one air duct to lead into the sleeping cabin.

A core concept of the present invention is that of the air no longer being pushed through the system, as is conventional, but rather being sucked through the system.

A preferred embodiment of the air-conditioning system according to the invention is explained by way of example below on the basis of the drawing, in which:

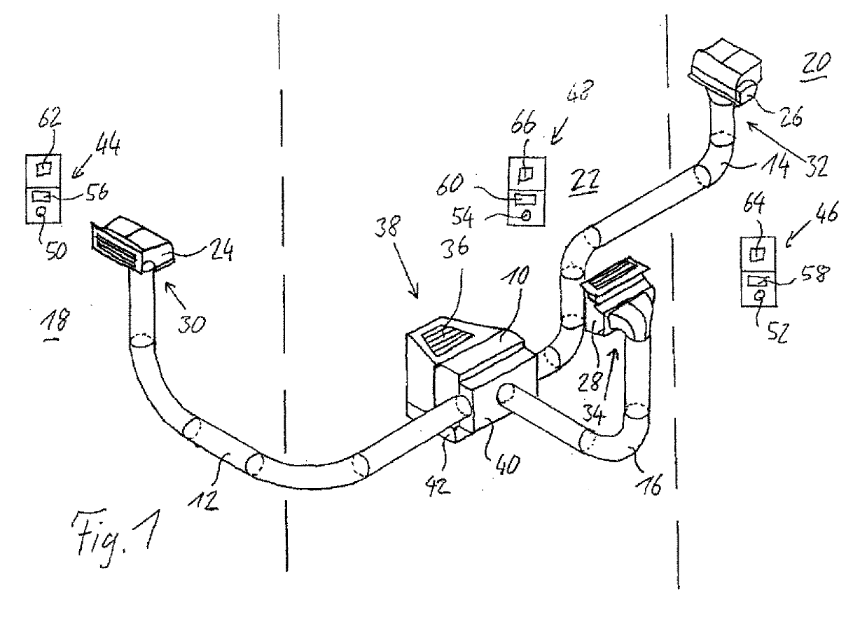

FIG. 1 is a schematic illustration of an embodiment of the air-conditioning system according to the invention.

The air-conditioning system illustrated has a compact air-conditioning module 38 which comprises at least the essential components which are required for conditioning the air. If the compact air-conditioning module 38 is provided both for cooling and also for heating, said components can comprise in particular a compressor, an evaporator which can at least partially form the heat exchanger, and a condenser. In addition, the heat exchanger can be at least partially connected to the cooling circuit of the vehicle in order to heat the air which is to be conditioned. Electrical heating devices are of course also conceivable. As already mentioned, the term ‘heat exchanger’ should also in the present connection comprise solutions in which a plurality of partial heat exchangers are provided. The compact air-conditioning module 38 has, in addition to the heat exchanger 10, an air distributor 40 to which are connected a first air duct 12, a second air duct 14 and a third air duct 16. The first air duct 12 leads to a first region to be air-conditioned 18, the second air duct 14 leads to a second region to be air-conditioned 20 and the third air duct 16 leads to a third region to be air-conditioned 22. A first fan 24 is provided in the outlet region 30 of the first air duct 12, a second fan 26 is provided in the outlet region 32 of the second air duct 14 and a third fan 28 is provided in the outlet region 34 of the third air duct 16. Although not strictly necessary in the context of the present invention, the compact air-conditioning module 38 comprises a further fan 36 which is arranged upstream of the heat exchanger 10 in order to supply the latter with sufficient fresh air and/or recirculated air (air sucked in from the interior space). The first region to be air-conditioned 18 is assigned a first operating unit 44, the second region to be air-conditioned 20 is assigned a second operating unit 46 and the third region to be air-conditioned 22 is assigned a third operating unit 48. The first operating unit 44 comprises a first operating button 50, with which the nominal temperature for the first region to be air-conditioned 18 can be predefined, a first display 56 on which the selected nominal temperature is displayed, and a first temperature sensor 62 with which the temperature in the first region to be air-conditioned 18 is measured. The second operating unit 46 comprises a second operating button 52, with which the nominal temperature for the second region to be air-conditioned 20 can be predefined, a second display 58 on which the selected nominal temperature is displayed, and a second temperature sensor 64 with which the temperature in the second region to be air-conditioned 20 is measured. The third operating unit 48 comprises a third operating button 54, with which the nominal temperature for the third region to be air-conditioned 22 can be predefined, a third display 60 on which the selected nominal temperature is displayed, and a third temperature sensor 66 with which the temperature in the third region to be air-conditioned 22 is measured. In the illustrated embodiment, a central controller 42 is provided which is connected by means of electrical lines (not illustrated) to the operating units 44, 46, 48. The controller 42 regulates in particular the rotational speed of the fan 24, 26, 28 and 36, specifically as a function of the respective temperature nominal and actual values. In addition, however, the controller 42 can also monitor and/or activate further components of the air-conditioning system. It is however likewise conceivable to provide a plurality of local controllers, for example in such a way that each operating unit is assigned a controller. In the embodiment illustrated, three temperature regulating circuits which can be operated independently of one another are formed, one for each region to be air-conditioned. On account of the fact that the air is at least predominantly sucked through the system, no back pressure or at least only a small back pressure is generated. In addition, it is possible in the ideal case to dispense with devices with which the outflow of air at the air outlets can be completely or partially prevented. If such devices are nevertheless to be provided, said devices can at least be of very simple construction.

The features of the invention disclosed in the above description, in the drawings and in the claims can be essential to the realization of the invention both individually and also in any desired combination.

### LIST OF REFERENCE SYMBOLS

10 Heat exchanger
12 First air duct
14 Second air duct
16 Third air duct
18 First region to be air-conditioned
20 Second region to be air-conditioned
22 Third region to be air-conditioned
24 First fan
26 Second fan
28 Third fan
30 Outlet region of the first air duct
32 Outlet region of the second air duct
34 Outlet region of the third air duct
36 Further fan
38 Compact air-conditioning module
40 Air distributor
42 Controller
44 First operating unit
46 Second operating unit
48 Third operating unit
50 First operating button
52 Second operating button
54 Third operating button
56 First display
58 Second display
60 Third display
62 First temperature sensor
64 Second temperature sensor
66 Third temperature sensor

1. An air-conditioning system for a vehicle, having a heat exchanger (10) which can be traversed by air and which is connected to a first air duct (12) and to at least one second air duct (14) which lead into regions to be air-conditioned (18, 20) of the vehicle, characterized in that the first air duct (12) is assigned a first fan (24) and the second air duct (14) is assigned a second fan (26), with the first fan (24) and the second fan (26) being designed to suck air emerging from the heat exchanger (10) in order to supply air to the regions to be air-conditioned (18, 20) of the vehicle.

2. The air-conditioning system as claimed in claim 1, characterized in that the first fan (24) is arranged in an outlet region (30) of the first air duct (32).

3. The air-conditioning system as claimed in claim 1 or 2, characterized in that the second fan (26) is arranged in an outlet region (30) of the second air duct (32).

4. The air-conditioning system as claimed in one of the preceding claims, characterized in that the heat exchanger (10) is assigned a further fan (36).

5. The air-conditioning system as claimed in one of the preceding claims, characterized in that the air feed quantity of at least one of the fans (24, 26, 36) can be regulated.

6. The air-conditioning system as claimed in one of the preceding claims, characterized in that the air feed quantity of the first fan (24) can be regulated as a function of the temperature in the region to be air-conditioned (18) of the vehicle into which the first air duct (12) leads.

7. The air-conditioning system as claimed in one of the preceding claims, characterized in that the air feed quantity of the second fan (26) can be regulated as a function of the temperature in the region to be air-conditioned (20) of the vehicle into which the second air duct (14) leads.

8. The air-conditioning system as claimed in one of the preceding claims, characterized in that the heat exchanger (10) is designed to supply heat and/or cold to the air which flows through it.

9. The air-conditioning system as claimed in one of the preceding claims, characterized in that the region to be air-conditioned (18) into which the first air duct (12) leads is structurally separate from the region to be air-conditioned (20) into which the second air duct (14) leads.
